(19) United States
(12) Patent Application Publication
(10) Pub. No.: US 2006/0049365 A1
(43) Pub. Date: Mar. 9, 2006

(54) Luminescent device

(76) Inventor: Patrick Colin Hickey, Edinburgh (GB)

Correspondence Address: OSTRAGER CHONG FLAHERTY & BROITMAN PC, 250 PARK AVENUE, SUITE 825, NEW YORK, NY, 10177, US

(21) Appl. No.: 10/542,916

(22) PCT Filed: Jan. 22, 2004
(86) PCT No.: PCT/GB04/00229

§ 371 Date: Jul. 20, 2005

(30) Foreign Application Priority Data
Jan. 22, 2003 (GB) 0301384.4

(51) Int. Cl. F21K 2/00

(52) U.S. Cl. 250/462.1

(57) ABSTRACT

A luminescent device comprises a gaseous tritium light source (GTLS). The GTLS is held within a housing which may optionally be located in an outer casing. A filter, such as a neutral density filter, may be used to modify the light output to predetermined levels. The device may be used to calibrate apparatus used to measure optical output, such as a luminometer.

The present invention relates to a luminescent device comprising a gaseous tritium light source. The device may be used, for example, to calibrate luminometers and other scientific apparatus measuring optical output.

Different types of scientific apparatus may be used to measure optical readings and frequently find utility in chemistry, biochemistry, biotechnology and medicine. Such optical readings are an effective, reliable and safe method for detection and analysis of molecules and living cell dynamics. Luminometers are one example of such scientific apparatus, and are used to measure the luminous output or luminescence of samples. The luminometer is based on a light-sensitive device termed a photomultiplier.

Other examples of light measuring equipment include a CCD (Charge Coupled Device) camera based imaging device such as the “Berthold Night Owl”, a scintillation counter, photomultiplier, a fluorometer, a spectrophotometer and a photodiode (in particular an avalanche photodiode).

It is important that apparatus reliant on optical analysis is regularly calibrated to ensure consistency of results. Current optical apparatus calibration devices may comprise a plurality of light emitting diodes of varying intensities. The apparatus is calibrated by checking that the reading of the apparatus corresponds to the known intensity of the light emitted from each of the light emitting diodes. Such calibration is also important when cross-referencing results from different machines.

These known calibration devices are expensive, and require a power source. This renders them relatively untransportable. The known calibration devices are also bulky and occupy the entire sample space allocated in the apparatus. Thus during calibration of the apparatus, testing must be stopped to insert the calibration device into the apparatus. It is not therefore possible to check the calibration of the machine whilst measuring test samples. There is thus a risk that the accuracy of the apparatus may decrease between calibrations, i.e. during testing, so that test results may be less accurate than is desirable.

WO 94/05983 discloses a multi-photomultiplier which utilises a radioactive material to provide a light output. Each photomultiplier component of the multi-photomultiplier described in WO 94/05983 is calibrated against another photomultiplier in the same multi-photomultiplier.

According to a first aspect of the present invention there is provided a luminescent device comprising a gaseous tritium light source (GTLS) which provides a light output of pre-determinable intensity.

Tritium (³H)is a radioactive gas that emits electrons which produce light through scintillation when they collide with a phosphor substance. Tritium has a half-life decay of (12.43+/−0.05) years and after this time the activity of the tritium source (and thus its luminescence) is decreased by half. The intensity of the light output will slowly decrease over time in accordance with this half-life decay. As the date of manufacture of the luminescent device is known, the half-life correction may be accurately calculated. The half-life correction may be calculated by means of a computer programme or from a half-life graph.

Thus, in contrast to WO 94/05983 discussed above, the present invention relates to a device where a gaseous tritium light source provides a light output of predeterminable intensity. The equipment to be tested is compared to a light source of pre-determinable intensity rather than being tested relative to another photomultiplier.

Preferably a number of distinct devices according to the present invention are provided, each providing a different pre-determinable light intensity. This facility for having a range of different pre-determinable light outputs is especially useful in the calibration of scientific apparatus measuring optical output, for example a luminometer, and enables calibration of the apparatus across the whole required range of light intensity. To achieve reduced light intensity, the device of the invention may comprise a light filtering means which predeterminably alters the intensity of the light output to produce a reduced light output. Suitable light reducing means include a neutral density filter, and the use of differing neutral density filters (e.g. of 1.0 giving 10% transmission; 2.0 giving 1% transmission) allowing the luminescence of the device to be reduced by a predetermined amount. Desirably the light outputs are selected to test the accuracy of the apparatus across the whole range of light intensity measurable. Where a luminometer is to be calibrated using one or more devices according to the present invention, preferably the device or devices will test the accuracy of the luminometer from at least 400 to 650 nm, suitably from at least 450 to 610 nm.

The luminescent device is desirably small enough to be housed in a sample holder of the scientific apparatus (e.g. luminometer, fluorometer, spectrophotometer, CCD camera, photodiode (like an avalanche photodiode), photomultiplier, scintillation counter or the like).

Preferably the luminescent device is shaped and sized to be suitable for insertion into an individual well of a standard size well plate, for example a 96, 384 or 1536 well plate. As the luminescent device of the present invention is small enough to be housed in a single well of a sample holder of a luminometer or other scientific apparatus measuring optical output, it is possible for the luminescent device to be left in the apparatus during use, even when other wells contain test materials.

The calibration of the scientific apparatus can therefore be checked for accuracy at each instance of use of the luminescent device of the present invention.

The luminescent device of the present invention may typically comprise the GTLS sealed in a housing which is not easily broken under normal working conditions. Suitably the housing is shatter, heat, cold and moisture resistant. Whilst the housing may be formed of any suitable material, examples include aluminium, brass, steel, plastics (e.g. polypropylene, acrylics and the like), carbon fibre and ceramics. However at least one portion of the inner housing will usually be. transparent or translucent (i.e. permits transmission of luminescence) and is unreactive to tritium. Mention may be made of glass (for example sapphire glass), plastic or a combination of these materials. Alternatively, the housing may include an aperture through which the light output is measured. In this embodiment, the GTLS will be retained within the housing by a suitable means, e.g. snug fit of the GTLS within the inner surface or, more usually an adhesive material and generally an outer casing including a transparent or translucent portion will be present.

Optionally, the housing for the GTLS is itself placed into a chamber of an outer casing having at least one optically transparent or translucent portion to permit transmission of the luminescence from the tritium source. The outer casing facilitates easy handling of the housing which is generally small and also acts as a suitable receptacle for holding any light filter required. The outer casing is typically formed from metal, preferably stainless steel, although other materials (e.g. brass, aluminium, plastics, ceramics etc) can also be used. The transparent or translucent end is suitably formed from glass or plastic. Optionally the transparent or translucent end comprises a neutral density filter.

The luminescent device may comprise colouring means to alter the colour of the light output to produce a coloured light output.

Typically the GTLS comprises 10 to 20 mCi of tritium, suitably 15 to 20 mCi, preferably 18 mCi (0.666 GBG) of tritium. A suitable GTLS for use in the present invention is available commercially from mb-microtec ag (Niederwanger, Switzerland).

In one embodiment the luminescent device according to the invention is sized and shaped to fit within a well in a well plate or the like. In this embodiment, the GTLS will normally be located within an inner housing which itself will be located within an outer casing. For convenience of handling (and especially removal of the device for the well) the outer casing will be of a magnetic material, such as steel. Optionally, the GTLS is located within the inner housing in a snug fit, so that the ends of the GTLS are not able to emit light and this improves the accuracy of the device for calibration or comparitive purposes. The GTLS will typically be 4.5 mm×1.6 mm.

In an alternative embodiment the GTLS may be fixed within a single housing and an array of filters spaced along the length of the GTLS. Conveniently the filters will be arranged in order of optical density. In this embodiment, the array of filters in a single device facilitates calibration of a microscope or CCD camera, and use of a single light source ensures calibration across the different filters.

In a further embodiment a scalebar graticule may be etched onto a filter so that the device may be used for measurement, typically of a sample viewed by a microscope or CCD camera. Photolithography may be used to manufacture the scalebar and the scale may be shown in mm or μm depending upon the apparatus.

According to a further aspect of the present invention there is provided a kit comprising two or more luminescent devices as described above, each providing a light output of pre-determinable and distinct intensity. Thus each of the luminescent devices provides a light output of a different pre-determinable intensity to the other devices present in the kit, and suitably the different intensities provided span the entire range of light intensity measurable by the scientific apparatus.

Optionally, the kit comprises 3, 4, 5, 6, or more devices, for example may contain 10, 12, 15 or 20 devices.

The kit may also include indicia recording the date(s) of manufacture of the devices, and means to calculate the intensity of the light output at any time from the date(s) of manufacture.

In some embodiments it may be desirable for the device of the present invention to include a magnetic component. The presence of a magnetic component allows the use of a magnetic handling tool and is especially useful for facilitating removal of small devices of the present invention from wells, such as from the well of a 96 well plate. Conveniently the magnetic component may be provided by use of an outer casing of a magnetic material such as steel.

The kit may also comprise colouring means to alter the colour of the light output. Suitably the light output of each luminometer calibration device is altered by the colouring means, to a different colour, and the kit provides a range of coloured light outputs.

Preferably the colouring means comprises one or more phosphors. Suitably the colouring means is provided by a phosphor coating on the GTLS housing.

According to a further aspect of the present invention there is provided a colourimetric equipment calibration device having a luminescent sample comprising GTLS which provides a light output of pre-determinable intensity and colouring means to alter the colour of the light output to produce a coloured light output.

According to a further aspect of the present invention there is provided a method of calibrating light measuring apparatus, comprising the steps of;
placing a luminescent device comprising gaseous tritium light source (GTLS) which provides a light output of pre-determinable intensity in the apparatus; and
adjusting the reading of light output of the apparatus to the pre-determined intensity of the light output of the luminescent device.

Where the luminescent device comprises colouring means to alter the colour of the light output to produce a coloured light output, the apparatus tested may be colourimetric equipment.

According to a further aspect of the present invention there is provided a light measuring apparatus comprising a luminescent calibration device comprising GTLS, wherein the luminescent calibration device is housed in a sample holder of the apparatus.

According to a further aspect of the present invention there is provided a method of analysing a sample, said method comprising the steps of;
i) calibrating an apparatus able to detect light output using a device as described above;
ii) inserting said sample into the calibrated apparatus and obtaining a reading therefor.

The sample may be any suitable sample comprising molecules and/or living cells. Usually the apparatus will be able to quantify the light output reading and may be for example, a luminometer, a fluorometer, a spectrophotometer, a scintillation counter, a photomultiplier, a photodiode (like an avalanche photodiode) or a CCD camera. The method may be applicable for techniques including drug discovery, high throughput screening (especially using a light reporter), molecular biology and diagnostic applications, but other uses are not excluded.

The present invention will now be described by way of example only with reference to the accompanying drawings in which;

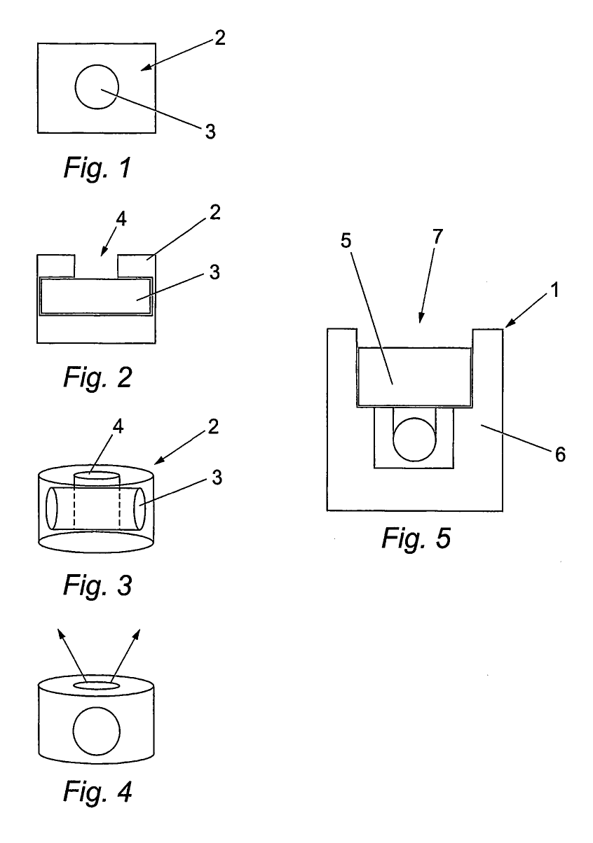

FIG. 1 show a side view of a GLTS insert within an inner housing formed from a material such as aluminium, brass, plastics or the like.

FIG. 2 shows a cross-sectional side view of the inner housing containing the GTLS of FIG. 1.

FIG. 3 shows a perspective view of the inner housing of FIGS. 1 and 2.

FIG. 4 shows the light output from the device of FIGS. 1 to 3.

FIG. 5 is a cross-sectional view of a device according to the invention having the housing of FIGS. 1 to 4 located within an outer casing and with a filter located thereon.

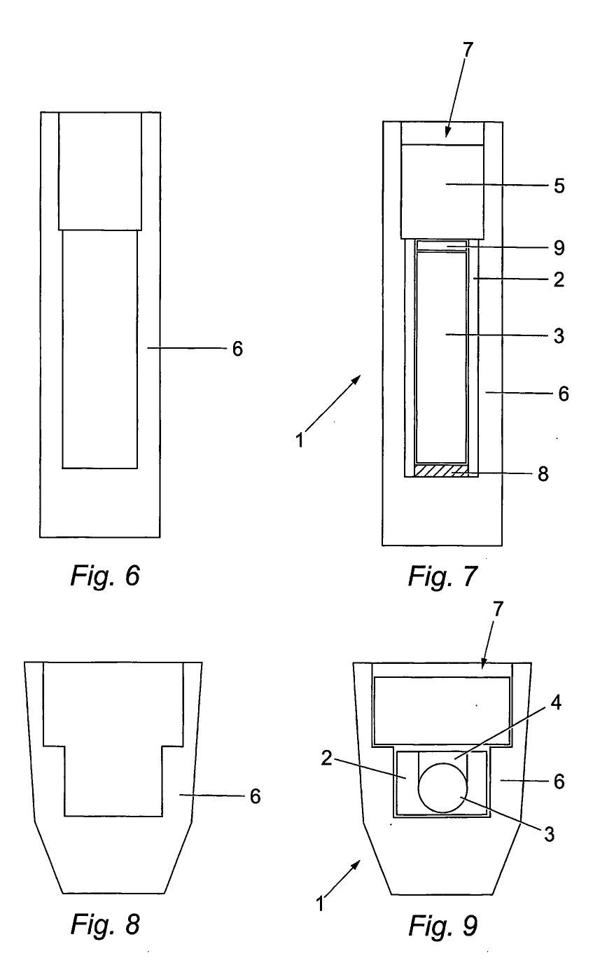

FIG. 6 is a cross-sectional view of an outer housing for a device according to the present invention modified for 384 well plates.

FIG. 7 shows a cross-sectional view of a device according to the present invention using the outer casing of FIG. 6.

FIG. 8 shows a cross-sectional view of an outer casing for a device according to the present invention for use in PCR or conical well plates.

FIG. 9 shows a cross-sectional view of a device according to the present invention using the outer casing shown in FIG. 8.

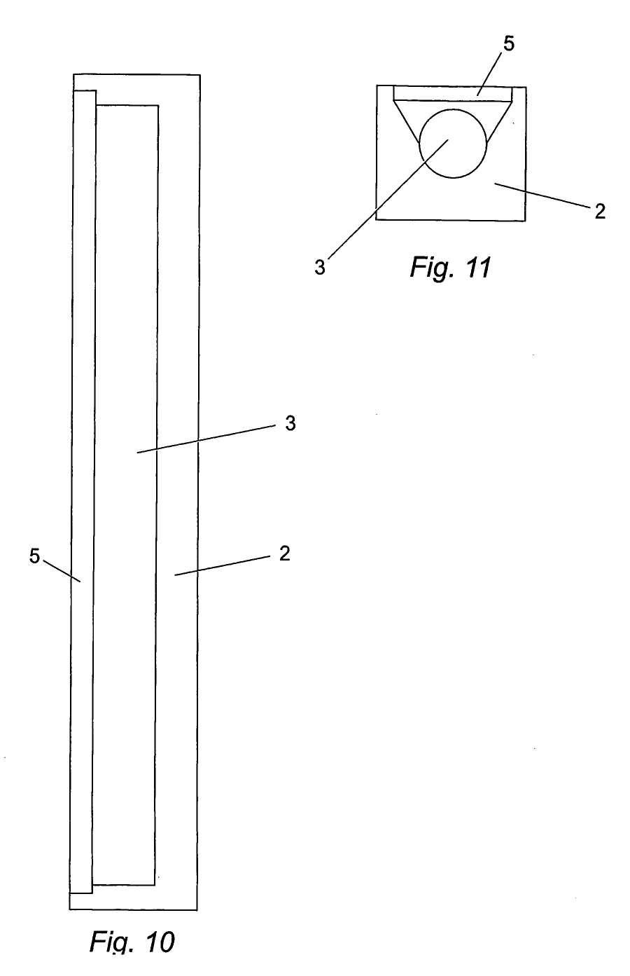

FIG. 10 shows a longitudinal cross-section of a device according to the present invention designed for use in a microscope or CCD camera.

FIG. 11 shows a lateral cross-section of the device of FIG. 10.

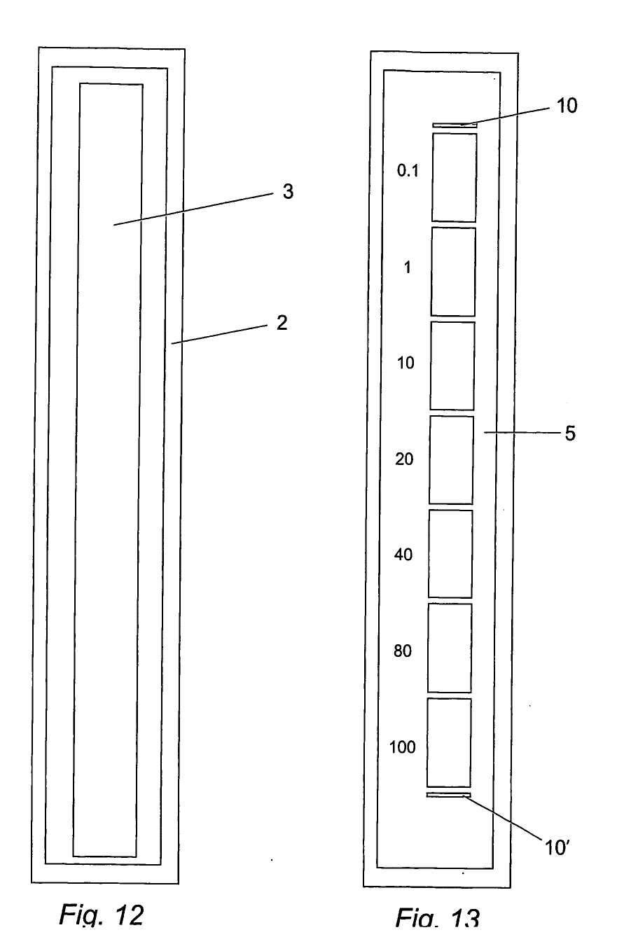

FIG. 12 shows a top view of the device of FIG. 10.

FIG. 13 shows an exemplary neutral density filter array for use in the device of FIGS. 10 to 12.

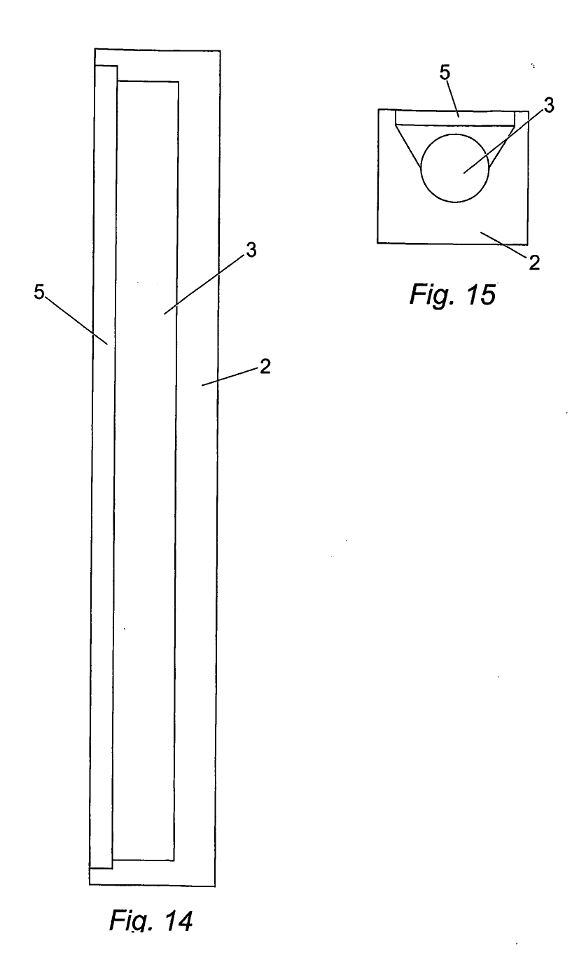

FIG. 14 shows a longitudinal cross-section of device according to the present invention for use in a self-luminescence scale bar or graticule calibration device.

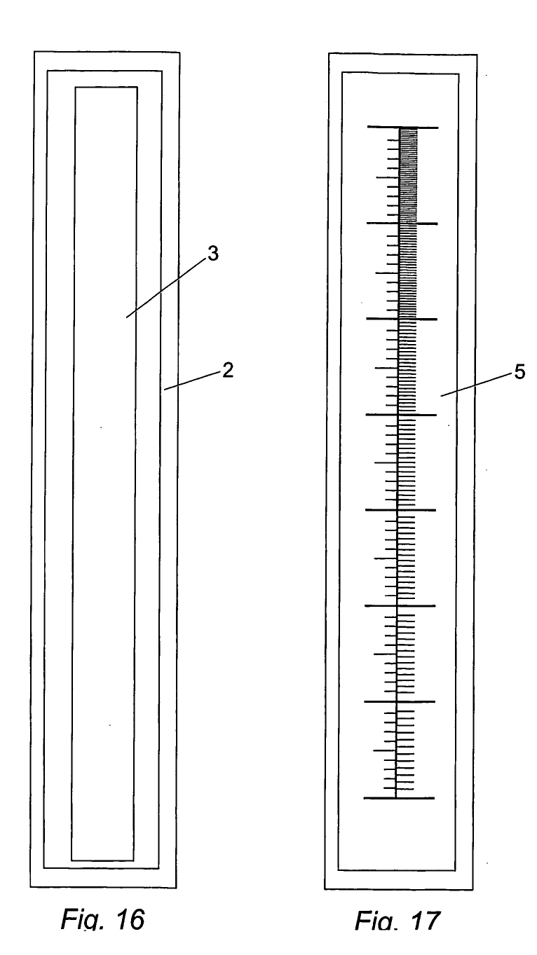

FIG. 15 shows a lateral cross-section of the device according to FIG. 14.

FIG. 16 shows a top view of the device according to FIG. 14.

FIG. 17 shows an exemplary scale bar graticule filter which may be used in the device of FIGS. 14 to 16.

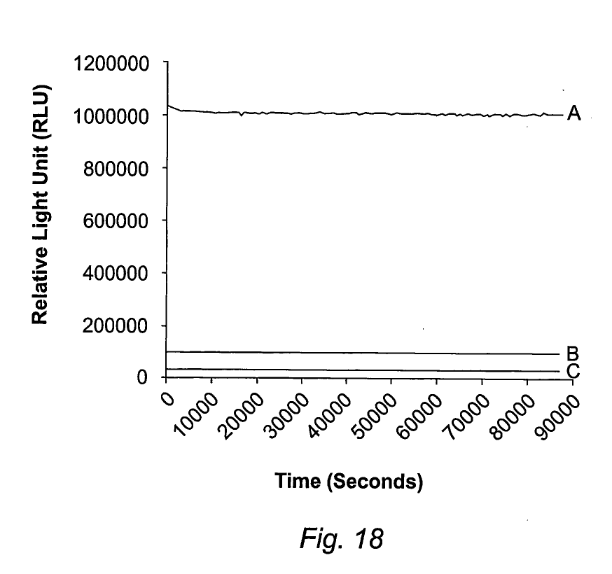

FIG. 18 shows data from three luminescent devices according to the present invention over a 24 hour period measured using a Mithras LB 940 luminometer (Berthold).

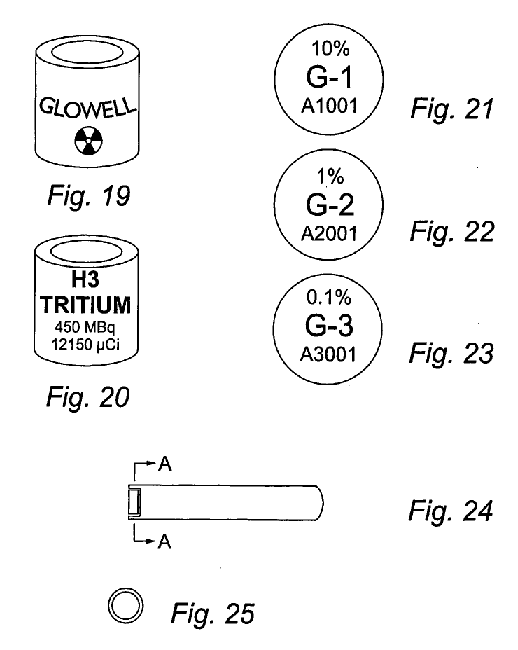

FIGS. 19 to 23 illustrate laser etching of luminescent devices according to the present invention.

FIG. 24 shows a longitudinal cross-section of a magnetic handling tool suitable for handling luminescent devices of the present invention.

FIG. 25 shows a lateral cross-section through line A-A in FIG. 24.

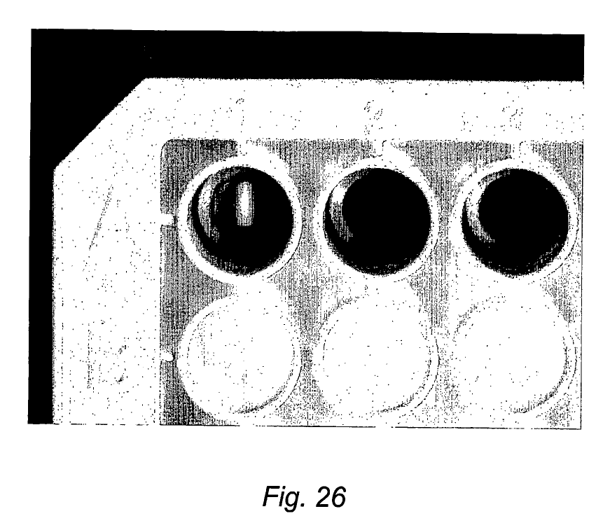

FIG. 26 is a photograph of three luminescent devices according to the present invention. Well A1 corresponds to calibration device A of FIG. 18; Well A2 corresponds to device B in FIG. 18 and Well A3 corresponds to the device C in FIG. 18.

With reference to the Figures, FIGS. 1 to 5 show an exemplary luminescent device according to the present invention designed for use in 96 well plates. The luminescent device (1) is constructed with an outer casing (6) constructed from stainless steel (416). The outer casing is susceptible to a magnetic field which enables the device to be easily extracted from the 96 well plate using a magnetic handling tool (for example as shown in FIGS. 24 and 25). The gaseous tritium light source (GSLS) (3) is fixed in place within an inner housing (2) using a silicon based adhesive. An aperture (4) in the top of housing (2) allows light to be admitted (see arrows at FIG. 4) and since the aperture is of a given diameter this means that the light output is uniform. The GTLS (3) within the housing (2) as shown in FIGS. 1 to 4 may be located within the outer casing (6) using an adhesive. A filter (5) formed of glass or other material is then secured across the aperture (4) for example using adhesive. The filter (5) can be of different optical density and exemplary filters include neutral density filters of 1.0 giving 10% transmission, neutral density filter of 2.0 giving 1% transmission of neutral density filter of 3.0 giving 0.1% transmission. Coloured filters may alternatively be used to filter what light of a specific wavelength.

An alternative embodiment of the present invention is shown in FIGS. 6 and 7 and illustrator modified design for the luminescent device for a 394 well plate. FIG. 6 shows an outer cases (6) which may conveniently be formed of magnetic metal, such as stainless steel. The size of the outer casing will be selected for insertion into an individual well of a 384 well plate but typically the length of the casing shown in FIG. 6 would be approximately 9 mm. FIG. 7 illustrates the formed device with the GTLS 3 being prelocated into a tubular housing (2) which may for example be aluminium. One end of the tubular housing (2) maybe sealed using a suitable sealant, for example silicon glue (8). The opposite end of the inner housing (2) may be sealed with a transparent or translucent material (9) for example glass, such as saphire glass. A glass filter (5) is placed over the free end of the inner housing such that light is emitted through aperture (7) of the outer casing (6).

An alternative embodiment of luminescent device according to the present invention is illustrated in FIG. 9 and is suitable for use in PCR or conical well plates. An outer housing (6) is shown in FIG. 8 and again an inner housing (2) similar to that illustrated in FIGS. 1 to 4 is present and contains the GTLS (3) a filter (5) is located over the top of the inner housing (2) and light is emitted through apertures (4) and (7).

FIGS. 10 to 13 illustrate a luminescent device according to the present invention designed for calibration of a microscope, CCD camera or other imaging system. In this embodiment the GTLS kit (3) is located within an inner housing (2) and is secured therein either through the internal size and shape of the inner housing (2) and/or through the use of an adhesive. A filter (5) is located over the GTLS. An exemplary filter having an array of different neutral densities thereon is illustrated in FIG. 13 and demonstrates the option of having different light outputs with a single GTLS lightsources. At each end of the neutral density filter array is a small bar (10 and 10′) in which the light is not filtered for comparative purposes.

FIGS. 14 to 17 illustrate an alternative embodiment of the present invention in which the luminescent device can be used as a self luminescence scale bar or graticule calibration device. The longitudinal cross section, lateral cross section and top view are similar to those of FIGS. 10, 11 and 12, but FIG. 17 shows an alternative exemplary filter in which a scale bar graticule has been etched thereon using lithography or mask techniques (similar to those used during production of a semi-conductor chip) and in which the scale can be selected from millimetres to micrometers.

FIG. 18 shows data from a calibration device over 24 hours measured using a Mithras LB 940 luminometer (Berthold). Three different devices according to the present invention were measured, each having a different density filter thereon. The devices are labelled A, B and C in the graph. Each device was measured for 0.1 seconds, at 360 second intervals over 24 hours. The average intensity of calibration device A was 1011763 relative light units (RLU); B equals 99163 RLU and C equals 27326 RLU.

FIGS. 19 to 23 illustrate the option of laser etching a luminescent device according to the present invention. Each device is labelled with the product type and with a unique serial number. Such labelling allows the luminescent device to the calibrated manufacture and to trace throughout its lifetime.

FIGS. 24 and 25 illustrate an exemplary magnetic handling tool for extracting luminescent devices according to the present invention and having a magnetic component within their manufacture from well plates, for example from 96 or 384 well plates. In the exemplary magnetic handling tool a neodymium disk magnet is fixed into a magnetic rod. Other magnet types could alternatively be used.

FIG. 26 illustrates the devices according to the present invention (the devices as illustrated in FIG. 18) in use in a 96 well plate. In sample A1 (corresponding to sample A of FIG. 18) the light intensity of the GTLS is strong and the GTLS is clearly visible. In sample A2 (corresponding to sample B in FIG. 18) a greater degree of filtering has been applied and in sample A3 (corresponding to sample C in FIG. 18) the filtering has again been increased.

I claim:

1. A luminescent device comprising a gaseous tritium light source (GTLS) which provides a light output of pre-determinable intensity.

2. A device according to claim 1, wherein the GTLS comprises 10 to 20 mCi of tritium.

3. A device according to claim 1, wherein the GTLS is located with an outer casing having at least one optically transparent or translucent portion.

4. A device according to claim 3, wherein the outer casing is steel.

5. A device according to claim 3, wherein the transparent or translucent portion comprises a neutral density filter.

6. A device according to claim 3, wherein the transparent or translucent portion is formed from glass or plastic.

7. A device according to claim 1, wherein the device further comprises colouring means to alter the colour of the light output of the GTLS.

8. A device according to claim 1, wherein the GTLS is held within a housing, the housing being located in the outer casing.

9. A device according to Claim 1, which is sized and shaped to calibrate the optical output of scientific apparatus.

10. A device according to claim 9, wherein said apparatus is selected from a group consisting of a luminometer, a fluorometer, a spectrophotometer, a scintillation counter, a photomultiplier, an avalanche photodiode or a CCD camera.

11. A device according to claim 1, wherein said device comprises a scalebar graticule.

12. A device according to claim 1, wherein said device comprises a filter array.

13. A kit comprising two or more luminescent devices according to claim 1, each of said devices providing a light output of a distinct intensity to the other devices of said kit.

14. A kit according to claim 13, further comprising a magnetic handling tool and wherein each of said devices includes a magnetic component.

15. A kit according to claim 12, comprising three or more devices, each having a light output of a distinct intensity to the other devices of said kit.

16. A light measuring apparatus comprising a luminescent device as claimed in claim 1, housed in a sample holder of said apparatus.

17. An apparatus according to claim 16, which is selected from the group consisting of a luminometer, a fluorometer, a spectrophotometer, a scintillation counter, a photomultiplier, an avalanche photodiode or a CCD camera.

18. A method of analyzing a sample, said method comprising;
i) calibrating an apparatus able to detect light output using a device as claimed in claim 1;
ii) inserting said sample into the calibrated apparatus and obtaining a reading thereof

19. A method as claimed in claim 18, wherein the sample comprises living cells.
